(19) United States
(12) Patent Application Publication
(10) Pub. No.: US 2018/0241687 A1
(43) Pub. Date: Aug. 23, 2018

(54) Technique For Multi-Connectivity

(71) Applicant: Telefonaktiebolaget LM Ericsson (publ), Stockholm (SE)

(72) Inventors: Torbjörn Wigren, Uppsala (SE); Torsten Dudda, Aachen (DE); Reem Karaki, Aachen (DE); Alexander Vesely, Feldbach (AT)

(21) Appl. No.: 15/759,260

(22) PCT Filed: Sep. 11, 2015
(86) PCT No.: PCT/EP2015/070904

§ 371 Date: Mar. 12, 2018

(51) Int. Cl. H04L 12/807; H04L 12/841; H04L 12/823

(52) U.S. Cl. CPC H04L 47/27; H04W 88/06; H04L 47/32; H04L 47/283

(57) ABSTRACT

A technique for sending data packets in a radio access network (304) including a master base station (308) and a secondary base station (310) for providing multi-connectivity to a user equipment (306) is described. As to a method aspect of the technique, at least one first data packet to be transmitted through the secondary base station (310) to the user equipment (306) is sent via a first link (314). A feedback including an acknowledgment for at least one second data packet transmitted through the secondary base station (310) to the user equipment (306) is received via a second link (316). An indicator for the at least one first data packet is delayed by a delay time depending on the first link (314) and the second link (316). At least one further data packet to be transmitted through the secondary base station (310) to the user equipment (306) is sent via the first link (314). The sending of the at least one further data packet depends on the delayed indicator for the at least one first data packet and the feedback for the at least one second data packet.

### TECHNICAL FIELD

The present disclosure generally relates to a technique for multi-connectivity. More specifically, and without limitation, a method and a device are provided for distributing data packets in a radio access network providing multi-connectivity to a user-equipment.

### BACKGROUND

Dual connectivity as an example for multi-connectivity is specified in Long Term Evolution (LTE) Release 12. A User Equipment (UE) may receive from and/or transmit to at least two different LTE base stations (evolved Node B or eNB) simultaneously. The two base stations are denoted as Master eNB (MeNB) and Secondary eNB (SeNB).

In an exemplary implementation, data flow from the core network to the MeNB is split at the MeNB. The MeNB routes subsets of data packets dynamically either directly to the UE or via a backhaul link to the SeNB, which transmits the received subset of data packets to the UE.

The data flow from the MeNB to the SeNB via the backhaul link is typically controlled by a flow control protocol at the MeNB. The flow control protocol conventionally relies upon status feedback provided by the SeNB to the MeNB. The feedback includes the highest successfully delivered Packet Data Convergence Protocol (PDCP) Sequence Number according to standard document 3GPP TS 36.425 V12.1.0, Sect. 5.5.3.6.

The existing feedback protocol provides, however, no information as to a filling state of a buffer at the SeNB. Therefore, the flow control at the MeNB receives no measurement values for the quantity that is to be controlled. One could modify the existing feedback protocol to also report the filing state of the SeNB buffer. However, this would require modifications at the SeNB, increase the complexity of the SeNB and add to the control signaling overhead on a backhaul network.

### SUMMARY

Accordingly, there is a need for a technique that allows controlling data flow in a multi-connectivity network that is more accurate at least in some situations.

As to one aspect, a method of sending data packets in a radio access network including a master base station and a secondary base station for providing multi-connectivity to a user equipment is provided. The method comprises performing or triggering the step of sending or controlling sending, via a first link, at least one first data packet to be transmitted through the secondary base station to the user equipment; the step of receiving, via a second link, a feedback including an acknowledgment for at least one second data packet transmitted through the secondary base station to the user equipment; the step of sending or controlling sending, via the first link, at least one further data packet to be transmitted through the secondary base station to the user equipment, wherein the sending or controlling sending of the at least one further data packet depends on the at least one first data packet, a delay associated with the first link and the second link, and the feedback for the at least one second data packet.

The method may further comprise the step of delaying an indicator for the at least one first data packet by a delay time depending on the first link and the second link. The sending or controlling sending of the at least one further data packet may depend on the delayed indicator for the at least one first data packet and the feedback for the at least one second data packet.

A number of the at least one further data packet may depend on the delayed indicator and the feedback. The number may be a rate, e.g., a number per time. Alternatively or in addition, the sending of the at least one further data packet may be scheduled, e.g., postponed, depending depend on the delayed indicator and the feedback.

The delay time depending on the first link and the second link may correspond to (e.g., at least) the first link and the second link. The delay time may correspond to a packet round trip from the master base station to the secondary base station and from the secondary base station to the master base station. The delay time may correspond to a sum of a first transport delay caused by the first link and a second transport delay caused by the second link. Alternatively or in addition, the delay time may include a processing delay at the master base station and/or the secondary base station.

The first link may be part of a downlink, e.g., for data transport. The second link may be part of an uplink, e.g., for control feedback.

The method may be performed at the master base station, e.g., as part of a flow control mechanism of the master base station. The step of sending or controlling sending the further data packets may realize the flow control mechanism, e.g., based on results of any one of the other steps (e.g., based on the delayed indicator and the feedback).

The delaying may align a time basis for the indicator and the feedback. A flow of the data packets, as controlled by the method, may compensate for the delay time in the master base station.

The sending of the at least one further data packet, e.g., the scheduling and/or the number of the further data packets, may be determined based on a comparison of the delayed indicator and the feedback. The comparison may include estimating a dwell time and/or a data volume of the secondary base station. The estimate may be performed at the master base station, e.g., using the delayed indicator and the feedback.

A result of the comparison, e.g., the estimate, may be used to compute a control error or deviation from a control objective, e.g., a filling state at the secondary base station. The sending of the at least one further data packet, e.g., the scheduling and/or the number of the further data packets, may be controlled so that the secondary base station is not running out of data packets to be transmitted to the user equipment. A frequency-shaping control may secure (e.g., global) stability of the feedback control mechanism.

At least in some embodiment, no express information as to a number of data packets currently outstanding at the secondary base station for transmission is provided to the master base station. In same or other embodiments, a transmission rate at which the data packets are transmitted from the secondary base station to the user equipment may change less rapidly than the delay time.

The master base station and/or the secondary base station may be modified to perform measurements of the transport delays. Alternatively or in addition, one or more measurements may be reported. E.g., the secondary base station may signal the first transport delay of the first link to the master base station.

Some or each of the data packets may include a sequence number. The indicator may include the sequence number of the latest data packet sent to the secondary base station. The data packets sent to the secondary base station may be pulled from a master buffer at the master base station. The delayed indicator, e.g., a delayed sequence number, may represent a delayed estimate for a top of a transmission window used by the secondary base station for transmitting the data packets to the user equipment.

The method may further comprise performing a frequency shaping control, e.g., when computing a control signal or generating a control command for the sending of the further data packets (e.g. for specifying the schedule and/or the number of the further data packets to be send to the secondary base station). The frequency shaping control and/or the computation of the control signal may be performed using a sampling time instance, e.g., at the master base station.

The at least one first data packet, the at least one second data packet and/or the at least one further data packet may be sent to the secondary base station for transmission to the user equipment. In one implementation, the data packets may be sent from the master base station to the secondary base station. E.g., a core network may provide the data packets to the master base station. In another implementation, the data packets may be sent directly from the core network to the secondary base station, e.g., under the control of the master base station via the first link.

The first link may be a backhaul link from the master base station to the secondary base station. The second link may be a backhaul link from the secondary base station to the master base station. The (e.g., first and/or further) data packets may be sent and/or the feedback may be received through an internode interface of the radio access network, e.g., an X2 interface. The first link and the second link may be one bidirectional link, e.g., the same physical link. The physical link may include at least one of a fiber-optic link and a microwave-radio link.

The secondary base station may include a secondary buffer, e.g., for the data packets received from the master base station. The data packets sent to the secondary base station may be stored in the secondary buffer, e.g., until a corresponding acknowledgment is received from the user equipment.

A window may indicate data packets to be transmitted through the secondary base station to the user equipment. The window may extend from a first window edge, L′, to a second window edge, H′. The data packets to be transmitted to the user equipment may encompass the data packets in the range from L′+1 to H′.

A size of the window, H′−L′, may be estimated based on the indicator, S, for the at least one first data packet. The second window edge H′ (e.g., at a second time of receiving the at least one first data packet from the master base station at the secondary base station) may correspond to the indicator S (e.g., at a first time of sending the at least one first data packet to the secondary base station at the master base station). The second time may be offset relative to the first time by the first transport delay.

Alternatively or in addition, the acknowledgment for the at least one second data packet (e.g., at a fourth time of receiving the feedback from the secondary base station at the master base station) may correspond to the first window edge L′ (e.g., at a third time of sending the feedback to the master base station at the secondary base station). The fourth time may be offset relative to the third time by the second transport delay.

The multi-connectivity may be a dual-connectivity provided by the master base station and the secondary base station to the same user equipment. Alternatively or in addition, the radio access network may include further secondary base stations. The master base station and the at least one secondary base station may provide the multi-connectivity to the same user equipment.

The radio access network may be (or may compatible with) a cellular access network, e.g., a Long Term Evolution (LTE) network. The master base station and/or the secondary base station may include an evolved Node B (eNB). Alternatively or in addition, the secondary base station may include an access point, e.g., of a Wireless Local Area Network (WLAN or WiFi).

The method may further comprise a step of measuring the delay time or receiving a measurement for determining the delay time. The delay time may be measured by the master base station and/or the secondary base station. A measurement, e.g., a partial measurement, for determining the delay time may be performed by the master base station and/or the secondary base station. Alternatively or in addition, the (e.g., partial) measurement may be received, e.g., at the master base station.

The delay time may be estimated based on a time measured for a one-way packet trip. The one-way trip may include a packet trip from the master base station to the secondary base station and/or from the secondary base station to the master base station. Estimating the delay time may include multiplying the time measured for the one-way packet trip with a factor. The factor may be in the range of 1.9 to 2.1, e.g., the factor may be equal to 2.

The method may further comprise storing in a master buffer at the master base station data packets received from a core network for (e.g., direct or indirect) transmission to the user equipment using the multi-connectivity. A portion of the received and/or stored data packets may be sent to the (at least one) secondary base station, e.g., based on the delayed indicator and the feedback. The at least one first data packet, second data packet and/or further data packet may be retrieved from the master buffer and/or sent from the master base station to the secondary base station. According to the multi-connectivity, data packets not sent to the (at least one) secondary base station may be transmitted through the master base station to the user equipment.

The method may be implemented at the master base station. The method may be implemented in a packet data convergence protocol (PDCP) layer. The data packets may be, or may include, PDCP packet data units (PDUs). The data packets sent to the (at least one) secondary base station may be sent to a radio link control (RLC) layer of the secondary base station. The data packets not sent to any of the at least one secondary base station may be sent to an RLC layer of the master base station. The data packets stored in the master buffer may be sent either to the RLC layer of the master base station or the RLC layer of the (at least one) secondary base station.

Each of the at least one first, second and/or further data packet may include the sequence number. The data packets may be sent to the secondary base station in the order of the sequence number. Alternatively or in addition, the data packets sent to the secondary base station may be transmitted by the secondary base station to the user equipment in the order of the sequence number.

The indicator may include the sequence number of the at least one first data packet. The acknowledgement may include the sequence number of the at least one second data packet. The sequence number of the at least one first data packet may be higher than the sequence number of the at least one second data packet. The sequence number of the at least one further data packet may be higher than the sequence number of the at least one first data packet.

The indicator (e.g., prior to delaying the indicator) may be indicative of the highest sequence number of the data packets sent to the secondary base station. Alternatively or in addition, the indicator (e.g., prior to delaying the indicator) may be indicative of the sequence number of the data packet most recently sent to the secondary base station. The at least one first data packet may include the data packet most recently sent to the secondary base station (e.g., among the data packets sent to the secondary base station).

The acknowledgement (e.g., when sent by the secondary base station in the feedback) may be indicative of the highest sequence number of the data packets successfully transmitted to the user equipment through the secondary base station. E.g., the at least one second data packet may be (or may include) the data packet most recently acknowledged by the user equipment (e.g., among the data packets sent to the secondary base station).

The method may further include receiving a requested amount, e.g., an amount of further data (e.g., in bytes) or an amount of further data packets (e.g., in number). The requested additional amount may be counted from the highest sequence number of the at least one second data packet that was successfully delivered (e.g., in sequence) to the user equipment.

The step of sending or controlling sending of the at least one further data packet may depend on the difference between the sequence number of the delayed indicator and the sequence number of the acknowledgment. The scheduling and/or the number of the further data packets sent to the secondary base station may depend on the difference.

The feedback may further include a requested window size. The number of the at least one further data packet may depend on the difference and the requested window size.

The indicator of the at least one first data packet may be sampled and/or subjected to a filter. The filter may be an infinite impulse response (IIR) filter.

The filter may depend on the delay time. The filter may be frequency-selective. The filter may suppress low-frequency components. The low-frequency suppression, e.g., a cut-off frequency, may depend on the delay time. The filter may be configured for (e.g., global) stability. E.g., the frequency-selectivity may depend on the delay time so as to achieve global stability of the feedback control mechanism.

As to a further aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download via a data network, e.g., via the radio access network and/or the Internet.

As to one hardware aspect, a device for sending data packets in a radio access network including a master base station and a secondary base station for providing multi-connectivity to a user equipment is provided. The device is adapted to perform or trigger the step of sending or controlling sending, via a first link, at least one first data packet to be transmitted through the secondary base station to the user equipment; the step of receiving, via a second link, a feedback including an acknowledgment for at least one second data packet transmitted through the secondary base station to the user equipment; and the step of sending or controlling sending, via the first link, at least one further data packet to be transmitted through the secondary base station to the user equipment, wherein the sending or controlling sending of the at least one further data packet depends on the at least one first data packet, a delay associated with the first link and the second link, and the feedback for the at least one second data packet.

As to another hardware aspect, a master base station for sending data packets in a radio access network including the master base station and a secondary base station for providing multi-connectivity to a user equipment is provided. The master base station may be connected or connectable to at least one of a core network and the secondary base station. The master base station may include the device according to the above aspect.

Alternatively or in addition, the master base station may comprise a first data packet sending module for sending or controlling sending, via a first link, at least one first data packet to be transmitted through the secondary base station to the user equipment; a feedback receiving module for receiving, via a second link, a feedback including an acknowledgment for at least one second data packet transmitted to through the secondary base station to the user equipment; and a further data packet sending module for sending or controlling sending, via the first link, at least one further data packet to be transmitted through the secondary base station to the user equipment, wherein the sending or controlling sending of the at least one further data packet depends on the at least one first data packet, a delay associated with the first link and the second link, and the feedback for the at least one second data packet.

The hardware aspects may further include any feature disclosed in the context of the method aspect. Particularly, any one of the modules, or a dedicated unit or module, may be adapted to perform one or more of the steps of the method aspect. E.g., the master base station may further comprise an indicator delaying module for delaying an indicator for the at least one first data packet by a delay time depending on the first link and the second link.

### BRIEF DESCRIPTION OF THE DRAWINGS

Further details of embodiments of the technique are described with reference to the enclosed drawings, wherein:

FIG. 1 illustrates a schematic block diagram of a device for sending data packets in a radio access network providing multi-connectivity;

FIG. 2 shows a flowchart for a method of sending data packets in a radio access network providing multi-connectivity;

FIG. 3 schematically illustrates a radio access network providing multi-connectivity to a user equipment;

FIG. 4 schematically illustrates a backhaul signaling based on which the data packets can be sent in the method of FIG. 2;

FIG. 5 illustrates a schematic block diagram for a control mechanism implementable by the method of FIG. 2;

FIG. 6 shows a schematic block diagram for a downlink transport;

FIG. 7 shows a schematic block diagram for generating a buffer window;

FIG. 8 shows a schematic block diagram for generating a feedback;

FIG. 9 shows schematic block diagrams for an uplink transport;

FIG. 10 shows a schematic block diagram for a system implementation;

FIG. 11 shows a schematic block diagram for a time-domain implementation, which corresponds to the block diagram of FIG. 5;

FIG. 12 schematically illustrates a Popov stability criterion;

FIG. 13 shows a first example of a Popov plot;

FIG. 14 shows a real part of the Popov plot of FIG. 13; and

FIG. 15 shows a second example of a Popov plot.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a Long Term Evolution (LTE) implementation, it is readily apparent that the technique described herein may also be implemented in any other wireless communication network, in combination with or including a Wireless Local Area Network (WLAN or WiFi) according to the standard family IEEE 802.11 (e.g., IEEE 802.11a, g, n, ac or ad) and/or a Worldwide Interoperability for Microwave Access (WiMAX) according to the standard family IEEE 802.16.

Moreover, those skilled in the art will appreciate that the services, functions, steps and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising a computer processor and memory coupled to the processor, wherein the memory is encoded with one or more programs that may perform the services, functions, steps and implement the modules disclosed herein.

In the description, latency is used interchangeably for delay. Downlink specifies a link from the master eNB to the secondary eNB, and uplink vice versa.

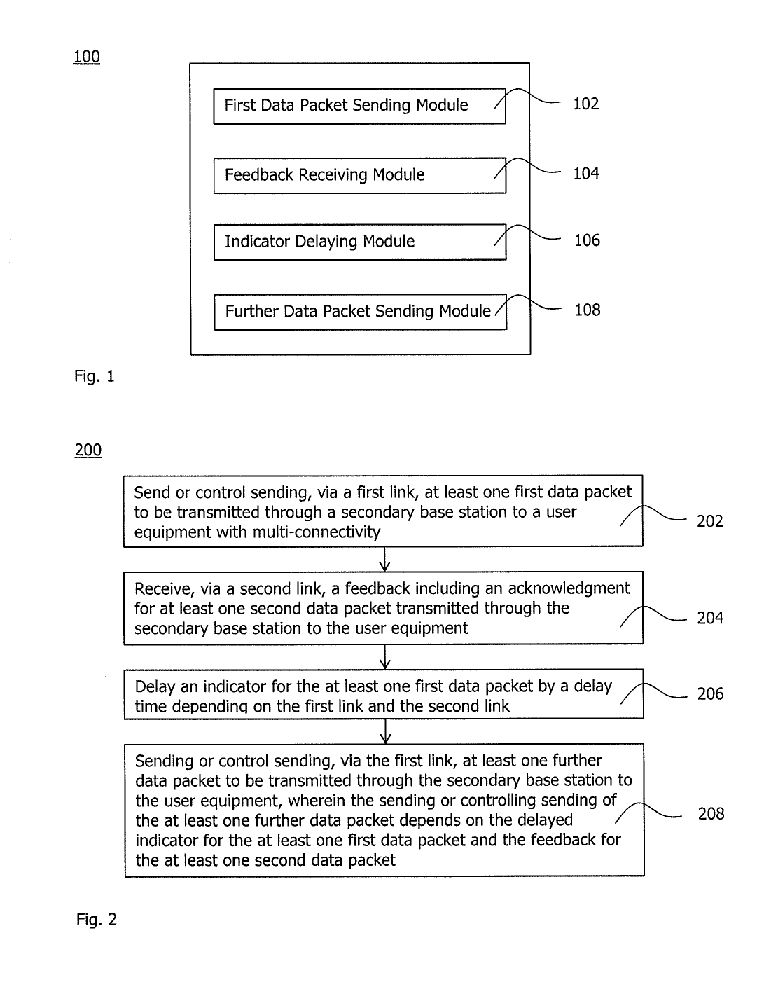

FIG. 1 schematically illustrates a block diagram of a device 100 for sending data packets in a radio access network for multi-connectivity, e.g., dual connectivity. The multi-connectivity may be provided to a user equipment by means of a master base station and at least one secondary base station.

The device 100 includes a module 102 for sending (or controlling sending) first data packets via a first link from the master base station to the secondary base station and a module 104 for receiving, via a second link, feedback from the secondary base station at the master base station. An indicator for the first data packets is delayed by means of a module 106. Depending on the delayed indicator and the feedback, a module 108 sends further data packets from the master base station to the secondary base station.

The modules may be implemented separately or in combination. E.g., the function of the modules 102 and 108 may be implemented by a combined data packet sending module.

The modules may be implemented in the radio access network, e.g. at the master base station, at a dedicated node or in a distributed manner. Alternatively or in addition, any of the modules may be implemented as a function module in a virtual node.

FIG. 2 shows a flowchart for a method 200 of sending data packets in a radio access network. The radio access network includes a master base station and a secondary base station for providing multi-connectivity to a user equipment. The method comprises performing or triggering a step 202 of sending (or controlling sending), via a first link, at least one first data packet to be transmitted through the secondary base station to the user equipment. In a step 204, a feedback including an acknowledgment for at least one second data packet transmitted through the secondary base station to the user equipment is received via a second link.

An indicator for the at least one first data packet is delayed in a step 206 by a delay time depending on the first link and the second link. Depending on the delayed indicator for the at least one first data packet and the feedback for the at least one second data packet, at least one further data packet to be transmitted through the secondary base station to the user equipment is sent (or the sending is controlled) via the first link in a step 208 of the method 200.

The device 100 may implement the method 200. E.g., the modules 102 to 108 may be configured to perform the step 202 to 208, respectively.

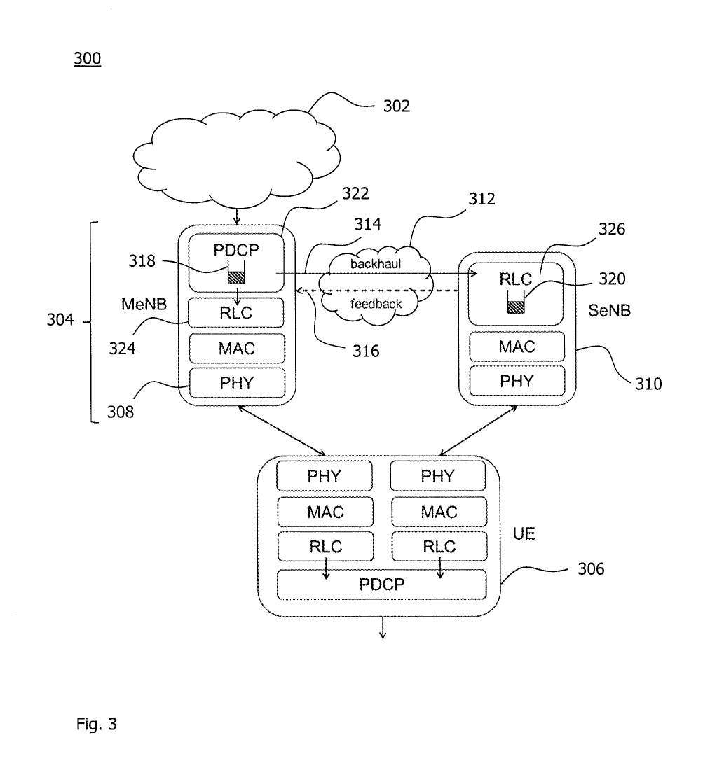

FIG. 3 schematically illustrates a telecommunications network 300 as an exemplary LTE environment for implementing the technique. The telecommunications network 300 includes a core network (CN) 302, a radio access network (RAN) 304 for radio multi-connectivity with a user equipment (UE) 306.

The technique is described with reference to FIG. 3 in the context of an LTE network 300, i.e. using an evolved Universal Mobile Telecommunications System (UMTS) Terrestrial Radio Access Network (E-UTRAN) as the RAN 304. It should be understood that features and effects described herein are equally applicable to wireless access networks and UEs 306 implementing other radio access technologies and/or standards. LTE is used as an example network environment. The technique is suitable for LTE (e.g., LTE-Advanced), and using LTE is particularly useful for understanding the technique and its advantages.

The RAN 304 comprises a master baste station 308, e.g., a master eNB (MeNB), and at least one secondary base station 310, e.g., a secondary eNB (SeNB). The MeNB 308 and the SeNB 310 are connected by a backhaul network 312. The backhaul connection includes a first link 314 from the MeNB 308 to the SeNB 310, which is also referred to as a downlink or transport link, and a second link 316 from the SeNB 310 to the MeNB 308, which is also referred to as an uplink or feedback link.

The MeNB 308 receives from the CN 302 data packets to be transmitted to the UE 306. The MeNB 308 includes a master buffer 318. The master buffer 318 includes data packets that are selectively sent to the SeNB 310. The SeNB 310 includes a secondary buffer 320 for data packets to be transmitted to the UE 306. The data buffers 308 and 310 may also be referred to as queues.

The data packets may include Packet Data Units (PDUs). In a split-bearer architecture, e.g., for LTE dual connectivity, the downlink data flow is split on a Physical Downlink Convergence Protocol (PDCP) layer 322 in the MeNB 308. The PDCP layer 322 routes PDCP PDUs dynamically either via a Radio Link Control (RLC) layer 324 of the MeNB 308 to the UE 306 or, according to the step 202, via the first link 314 (that is also referred to as a first backhaul channel) to the SeNB 310. A RLC layer 326 of the SeNB 310 stores the received PDUs in the secondary buffer 326 and transmits the stored PDUs to the UE 306.

Solid arrows in FIG. 3 indicate (potential) directions of user plane data. The dashed arrow indicates a direction for the feedback according to the step 204. The feedback includes an acknowledgment 424 used for flow control between the eNBs 308 and 310 according to the step 308.

The data buffers 318 and 320 are illustrated in the MeNB 308 and SeNB 320, respectively. While FIG. 3 illustrates an implementation location in the MeNB PDCP 322 and SeNB RLC 326 for data buffers 318 and 320, respectively, the data buffers 318 and/or 320 may also be implemented in another layer, across multiple layers or in a dedicated protocol layer. The terms “backhaul” and “transport” may be used interchangeably.

The feedback between the MeNB 308 and the SeNB 310 may be required for the split-bearer operation in dual connectivity, e.g., to balance the data flow between MeNB 308 and SeNB 310. The feedback allows the MeNB 308 to determine how much data it needs to send to the SeNB 310 so that the SeNB 310 transmitter queue 320 is neither underutilized nor overloaded.

The technique may be implemented using LTE and WiFi aggregation. Similarly to dual connectivity in LTE, LTE and WiFi may be aggregated. In one example protocol architecture, the data splitting point is the same as in the split-bearer architecture of dual connectivity, i.e. on the PDCP layer of the MeNB 308. Instead of an LTE SeNB 310 (as illustrated in FIG. 3), a WiFi access point is employed as the secondary base station 310. Instead of the RLC protocol 326 (and optionally a Medium Access Control protocol and/or Physical layer protocol) at the secondary base station 310, WiFi protocols may be employed at the secondary base station 310. The same applies to the protocol layers in the UE 306 for a connection to the WiFi access point 310.

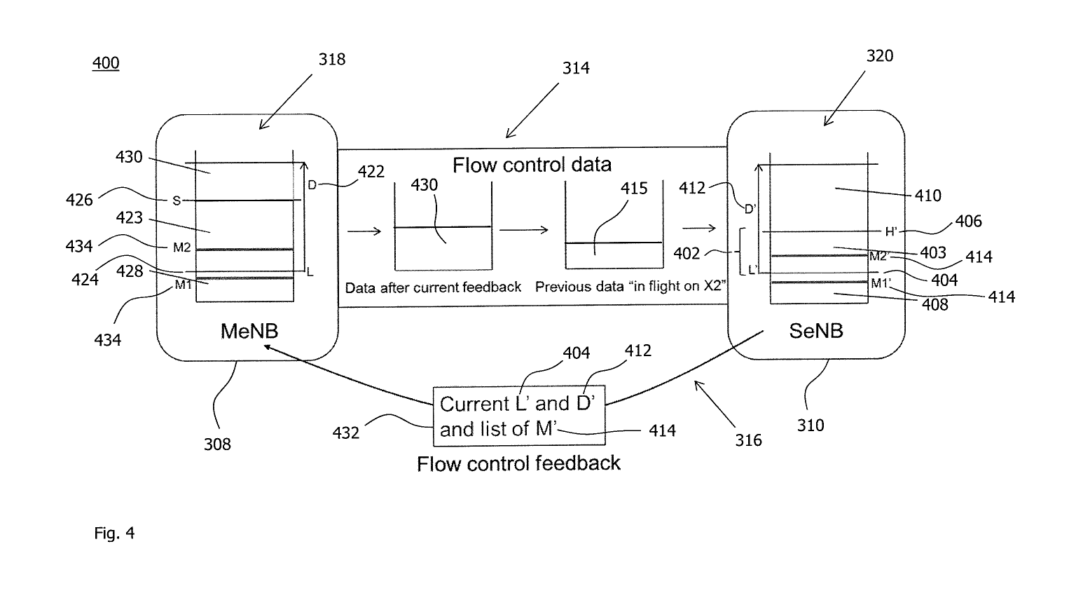

A backhaul signaling 400 for controlling a flow of the data packets is schematically illustrated in FIG. 4. The method 200 controls the flow of the data packets using a window 402. The device 100 performing the method 200 may be implemented at the MeNB 308. The method 200, e.g., the step 208, implements a controller for the flow of the data packets. E.g., the module 108 may be referred to as the controller.

FIG. 4 depicts quantities used in an embodiment of the technique. A lower edge L′ of the window 402 is shown at reference sign 404 and an upper edge H′ of the window 402 is shown at reference sign 406. The lower edge 404 is a highest sequence number of those PDUs that have been successfully transmitted to the UE 306. The upper edge 406 is a highest sequence number of those PDUs that are stored in the secondary buffer 320 for transmission to the UE 306. The window 402 includes the PDUs 403 having sequence number in the range of L′+1 to H′. Previously (and at least in part successfully) transmitted PDUs 408 have sequence numbers up to, and including, L′.

The difference H′−L′ corresponds to the PDUs in the secondary buffer 320 currently available for transmission at the SeNB 310. Alternatively or in addition, the window 402 comprises those PDUs 403 in the secondary buffer 320 that are not acknowledged to the MeNB 308.

Storage locations 410 in the secondary buffer 320 are available for the further PDUs 430. An amount D′ of PDUs requested by the SeNB 310 is shown at reference sign 412. Individual PDUs (M1, M2, etc.) that are declared to be lost at the SeNB 310 are indicated at reference sign 414.

The feedback 432 from the SeNB 310 as sent to the MeNB 308 includes the current lower edge 404, which is received as the acknowledgement 424 for the second PDUs 408. Optionally, the feedback 432 further includes the amount 412 of requested PDUs and/or a list of the lost PDUs 414.

From the perspective of the MeNB 308, the first PDUs 423 (as the first data packets) are already sent to the SeNB 310 according to the step 202. The indicator S is a highest sequence number of the PDUs sent to the SeNB 310. The first PDUs 423 may include data packets 415 that are still “in flight” on the first backhaul link 314, e.g., on an X2 link or at an X2 interface. Alternatively or in addition, the first PDUs 423 may include the PDUs 403 already stored in secondary buffer 320.

The controller may control a filling level and/or a dwell time of the PDCP PDUs 403 in the window 402 of the SeNB 310. In one embodiment, the step 208 controls the secondary buffer 320 according to a control objective. The control objective may include minimizing the dwell time of PDUs 403 at the SeNB 310. Alternatively or in addition, the control objective may include sufficient margins for the data volume 403 retained at the SeNB 310 to avoid an empty window 402. E.g., the control objective may require that the difference H′−L′ exceeds a predefined threshold.

The window 402 might become empty, e.g., in case of a sudden increase of an air interface capacity (between the SeNB 310 and the UE 306) that would allow the secondary buffer 320 to run empty before the controller has a chance to send further data packets according to the step 208. The result would be an unwanted interruption of the data transfer.

One embodiment defines the control objective based on the feedback 432 including the requested window size 412 received at the MeNB 308 from the SeNB 310. From the perspective of the MeNB 308, the current window 402 is not known but estimated based on the feedback 432.

The feedback 432 as received at the MeNB 308 is delayed, e.g., due to the transport on the second backhaul link 316. Quantities defined at the MeNB 308 are labeled without apostrophe. Quantities defined at the SeNB 310 are labeled with an apostrophe. A sequence number 424 for the highest acknowledged sequence number, as received at the MeNB 308 in the step 204, is L. The highest acknowledged sequence number is also referred to as the acknowledgment 424. The acknowledgment 424 for the second PDUs 408 is based on the reported sequence number 404, i.e., the highest acknowledged sequence number L′ received at the SeNB 310 from the UE 306. A time dependency of the highest acknowledged sequence number 404 at the SeNB 310 and the highest acknowledged sequence number 424 at the MeNB 308 may be related according to L(t−T_{UL})=L′(t), wherein T_{UL} is the transport delay of the second backhaul link. The acknowledgment 424 defines, at the MeNB 308, a bottom of a window estimated for the window 402 of the SeNB 310.

A top 426 of the estimated window is defined based on the highest sequence number, S, transmitted from the MeNB 308 in the step 202. This means that the difference between these two values S and L represents the packets in flight in the first link 314 from the MeNB to the secondary eNB, in the secondary buffer 320 of the SeNB 310 and in the wireless interface to the UE 306. The two values, S and L, are known in the MeNB 308. However, the difference S-L does not accurately define a control feedback determined by a reception rate of the UE 306 and/or a channel capacity of the radio connectivity from the SeNB 310 to the UE 306. Only if all transport delays were negligible, the difference S-L would represent the size H′−L′ for the window 402 of the SeNB 310.

At least some conventional techniques do not take into account delays, e.g., transport delays associated with the backhaul network 312. Thus, the conventional controller is affected by at least one of a delay caused by the first link 314 (i.e., a downlink transport network from the MeNB to the SeNB), a dwell time delay of the secondary buffer of the SeNB, and a delay in the downlink and uplink radio transmission of data packets from the SeNB to the UE and back. Furthermore, a conventional estimate is inaccurate due to a signaling delay cause by the second link 316, i.e., the uplink transport network from the SeNB to the MeNB, which affects the signaling of the latest acknowledged PDCP PDU and the requested SeNB window.

The step 204 uses the feedback 432 received in the step 204 as a flow control feedback for a refined estimate of the window 402. Based on the estimated window, the flow of data packets, i.e., the sending of the further data packets, is controlled according to the step 208. The embodiment may further achieve global stability by frequency shaping in a signal path the control mechanism.

A first embodiment uses control signaling defined in document 3GPP TS 36.425, V12.1.0, for the feedback 432. The feedback 432 includes at least one of the highest successfully delivered PDCP PDU 404 received as the acknowledgment 424, a number of requested additional bytes 412, and the missing PDUs 414 on the backhaul interface X2. In a second embodiment, additionally information is included in the flow control feedback 432 that is sent from SeNB 310 to MeNB 308. The additional information includes at least one of a latency estimate or a latency measurement of the one-way latency on the backhaul channel 312 from MeNB 308 to SeNB 310.

The measurement can be obtained, e.g., by calculating a time difference between a sending time and a receiving time of one or more data packets on the backhaul network 312. E.g., the time difference is calculated using the first data packets 423, the second data packets 408 and/or the further data packets 430 on the first link 314 (i.e., the downlink). For this purpose, the MeNB 308 includes a timestamp (e.g., indicative of the sending time) in each data packet sent by the MeNB 308 via the first link 314 in the backhaul network 312 to the SeNB 310.

If the downlink transport delay and the uplink transport delay are equal (e.g., as an approximation or by construction of the backhaul network 312), the delay time is determined using the above additional information. If the downlink and uplink transport delays differ, e.g., due to different uplink and downlink loads, the method 200 further comprises measuring or triggering measuring the uplink transport delay, e.g., implemented in the MeNB 308.

The measurement includes calculating a further time difference between sending time and receiving time of uplink data. For this purpose the SeNB 310 includes a timestamp for the sending time, e.g., in the feedback 432 sent via the second link 316 on the backhaul network 312 to the MeNB 308.

The feedback 432 may be provided periodically, e.g., in the first or second embodiment. In one implementation of the second embodiment, each feedback 432 includes the additional information. E.g., the additional information is sent based on a feedback periodicity used also for other feedback indications (e.g., the highest successfully delivered PDCP PDU, the requested bytes, the missing X2 PDUs as described above). In another implementation, lower feedback periodicities may be used, e.g., in the range of 10 ms to 20 ms or 100 ms. Alternatively, the feedback 432 is provided at the feedback periodicity and the additional information is included in every n-th feedback 432.

Alternatively or in addition, the feedback 432 is provided upon request. In one embodiment, the SeNB 310 provides the feedback 432 only upon (e.g., explicit) request from the MeNB 308.

In one implementation, the feedback 432 is requested by inserting the sending timestamp in the data packets sent from the MeNB 308 to SeNB 310. The SeNB 310 determines whether the timestamp is present in the data packet. If the timestamp is present, the SeNB 310 provides the feedback 432, e.g., according to the first embodiment, and/or includes the additional information (e.g., a backhaul latency measurement result) according to the second embodiment.

Optionally, the SeNB 310 initiates time stamping upon the request. The time stamping enables measurements of the uplink transport delay. Alternatively or in addition, probing signals are used to measure the time delay, e.g., according to an Internet Control Message Protocol (ICMP), such as a ping command for measuring a round-trip time. The probing signals may be sent by the MeNB 308 on the first link 314 and reflected by the SeNB 310 on the second link 316.

The technique may be implemented assuming that an outgoing air interface rate at the SeNB 310 (i.e., a transmission rate from the SeNB 310 to the UE 306) is known at the MeNB 308. Alternatively or in addition, for any given implementation (e.g., at the SeNB 310) of computing the requested amount 412 as a function of the backhaul delay (e.g., the reported downlink transport delay) and the outgoing air interface rate, the MeNB 308 may compute (e.g., using the inverse of the function) the outgoing air interface rate of the SeNB 310. Furthermore, e.g., as an alternative to computing or estimating the outgoing air interface rate of the SeNB 310, the feedback 432 may signal the outgoing air interface rate. A sending rate at the MeNB 308 may be derived in the step 208 based on the outgoing air interface rate. For example, the sending rate at the MeNB 308 may be equal to the outgoing air interface rate of the SeNB 310.

An implementation of the technique is described in more detail. Any subset of function modules described for the implementation can be combined with above embodiments. In symbols used below, a subscript “S” denotes a quantity available at the SeNB 310, a subscript “M” denotes a quantity available at the MeNB 308, a subscript “DL” denotes a quantity related to the downlink transport channel, i.e., the first link 314, and a subscript “UL” denotes a quantity related to the UL transport channel, i.e., the first link 316.

The downlink transport delay is denoted by T_{DL}. The uplink transport delay is denoted by T_{UL}. A current time is denoted by t. The latest acknowledged sequence number 404 in the SeNB 310 is denoted by y_{UL,S}(t). The sequence number 426 of the currently transmitted PDCP PDU is denoted by q_{DL,M}(t).

If the error or deviation from the control objective was computed according to

requestedWindow−(q_{DL,M}(t)−y_{UL,S}(t−T_{UL})),

e.g., by sending the number of PDCP PDUs that corresponds to this quantity, this quantity does not represent the number of PDCP PDUs in the window 402 of the SeNB 310. Rather, it is based on a number of data packets that are in flight. This is, however, not the quantity that should be subject to the feedback control. It should rather be the number, H′−L′, of PDCP PDUs in the SeNB 310, or equivalently, the dwell time.

In order to obtain a more accurate estimate of the size, H′−L′, of the window 402 of the SeNB 310 for use in the MeNB 308, the best available information at the MeNB 308 for the bottom 404 of the window 402 (optionally including the data packets “in flight” from the SeNB 310 to the UE 306) is the acknowledgment 424, that may be representable by the quantity

y_{UL,M}(t)=y_{UL,S}(t−T_{UL}).

That is, y_{UL,M}(t) is the acknowledgment 424 on the latest acknowledged PDCP PDU (i.e., the second data packet 408 for estimating the bottom 404 of the window 402 of the SeNB 310) that is received in the MeNB 308 at time t. The acknowledgment 424 is delayed by the uplink transport delay T_{UL} relative to the time when the feedback including the current bottom 404 was actually valid and/or sent.

Therefore, the best estimate of the volume H′−L′ of data packets 403 in the window 402 of the SeNB 310 is q_{DL,S}(t−T_{UL}), wherein q_{DL,S}(t) denotes the packet number of the top 406 of the window 402 of the SeNB 310 at time t. However, due to the downlink delay, the first data packet 423 represented by the quantity q_{DL,S}(t−T_{UL}) at the SeNB 310 was sent from the MeNB 308 at time t−T_{UL}−T_{DL}, i.e.

q_{DL,S}(t−T_{UL})=q_{DL,M}(t−T_{UL}−T_{DL})

Thus, the control estimate of the volume H′−L′ of data 403 in the window 402 of the SeNB 310 is

w_{est,S}(t)=q_{DL,M}(t−T_{UL}−T_{DL})−y_{UL,M}(t).

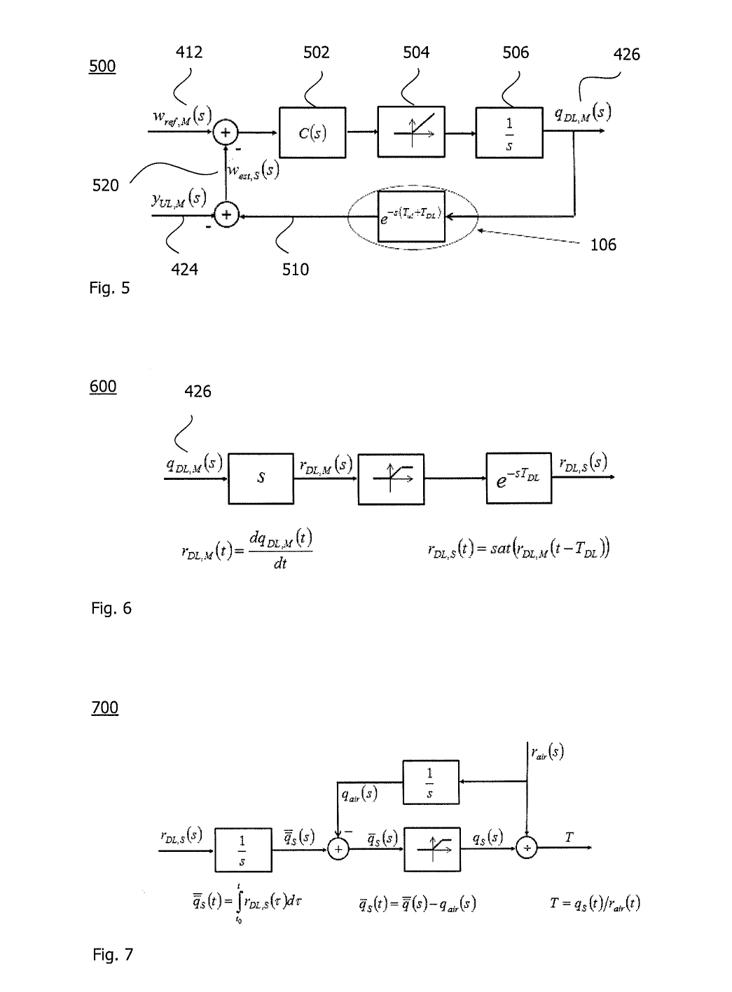

FIG. 5 shows a schematic block diagram 500 for a Laplace-transformed representation for the steps 206 and 208. The indicator 426 is delayed by the indicator delaying module 106 resulting in the delayed indicator shown at reference to sign 510. The control estimate used in the step 208 is shown at reference sign 520.

The delayed indicator 510, i.e., the quantity q_{DL,M}(t−T_{UL}−T_{DL}) is generated by delaying the sequence of the sequence number, i.e., the indicator 426, for PDCP PDUs (i.e., the first data packets) sent from the MeNB 308 using the module 106, e.g. implemented by a delay buffer in the MeNB 308. The delay buffer may store the time-stamped sequence number 426 for later generation of the sequence w_{est,S}(t).

In the block diagram 500, w_{ref,M}(s) is the Laplace transform of the reference signal (i.e., the requested window size 412), C(s) is a frequency-shaping controller transfer function 502, 1/s denotes integration that transforms the commanded sequence number rate at the output of C(s) to the Laplace transform of the transmitted sequence number q_{DL,M}(s). This quantity is then fed back to the delay buffer 106 depicted in FIG. 5, wherein the Laplace transform e^{-s(T}^{_{UL}}^{+T}^{_{DL}}⁾ represents the delay time T_{UL}+T_{DL}. y_{UL,S}(s) and w_{est,S}(s) are the Laplace transforms of the time signals y_{UL,S}(t) and w_{ref,S}(t), respectively. The block 504 between C(s) and 1/s is a saturation (in the absence of uplink data).

The delay buffer may be implemented in the MeNb 308. The delay buffer may be a circular buffer

An implementation of the control mechanism, e.g., implemented by the step 208, is described. The block diagram 500 in FIG. 5 is implemented at the MeNB 308.

FIG. 6 shows a schematic block diagram 600 for the downlink transport via the first link 314. Quantities indicated in FIG. 6 include the Laplace transform q_{DL,M}(s) of the sequence number (SN) signal of indicator 426 at the MeNB 308, the Laplace transform r_{DL,M}(S) of the SN rate of the MeNB 308 and the Laplace transform r_{DL,S}(s) of the SN rate received at the SeNB 310. e^{-sT}^{_{DL}} represents the delay of the downlink transport channel. The downlink transport delay may be on the order of 100 ms to 300 ms, e.g., 200 ms.

A rate limitation of the middle block is due to the Shannon theorem, i.e., every channel is characterized by a maximal rate. Therefore, a transformation to rate is allows to obtain a correct control system modeling.

FIG. 7 shows a schematic block diagram 700 of the window generation in the SeNB 310. Quantities shown in FIG. 7 include the Laplace transform rₐᵢᵣ(s) of the outgoing sequence number rate over the air interface, the Laplace transform qₐᵢᵣ(s) of the integrated outgoing sequence number rate, i.e. the outgoing sequence number over the air interface, and the Laplace transform q̅(s) of the integrated incoming sequence number rate, i.e. the incoming sequence number of the received PDCP PDU.

The circles with + and ÷ denote addition and division. The division is to be interpreted as done in the time domain, not in the Laplace domain.

The saturation block (after the summation) represents the fact that the data volume of the secondary window is positive and bounded by the storage capacity of the buffer.

T is the estimate of the dwell time of the window, obtained by a time domain division. Below, it is assumed that the outgoing air interface rate is known in the MeNB 310. In case it is known how the requested amount 412 is computed from the backhaul delay and the outgoing transmission rate at the SeNB 310, a back computation may be performed to derive the outgoing sending rate at the MeNB 308. Otherwise, additional feedback signaling may be implemented.

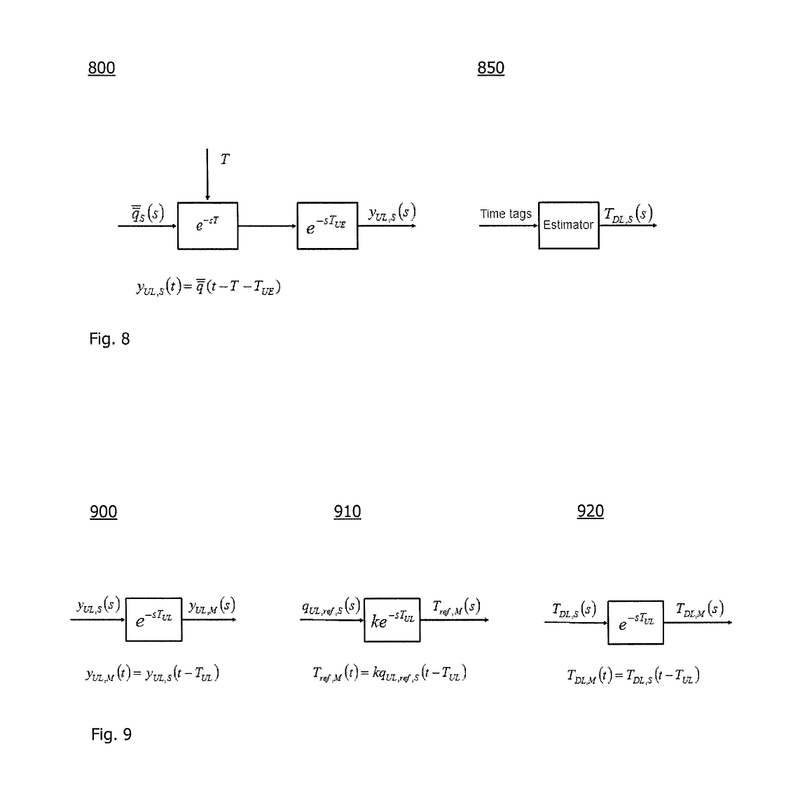

FIG. 8 shows a schematic block diagram 800 for generating the feedback 432 in the SeNB 310. The estimate 850 of the downlink delay is, in general, a time varying signal. It may be assumed that the time variation is so slow that it can be approximated as constant.

Quantities shown in FIG. 8 include the Laplace transform y_{UL,S}(s) of the current highest acknowledged sequence number 404 in the SeNB 310, the Laplace transform T_{DL,S}(s) of the estimated downlink transport delay, and T_{UE} represents the “acknowledgement” delay due to UE processing, UE reception and UE transmission. FIG. 9 shows a schematic block diagrams 900, 910 and 920 for the uplink transport of the feedback 432 via the second link 316. Quantities shown at 900 include e^{-sT}^{_{UL}} representing the Laplace transform of the uplink transport delay. At 910, q_{UL,ref,S}(s) represents the Laplace transform of the requested window size 412 of the SeNB 310. k is a scale factor that transforms the window size to a time reference value. At 902, T_{DL,M}(s) represents the Laplace transform of the downlink transport delayed, as received as feedback 432 at the MeNB 308. This quantity may be treated as constant for the purpose of stability analysis.

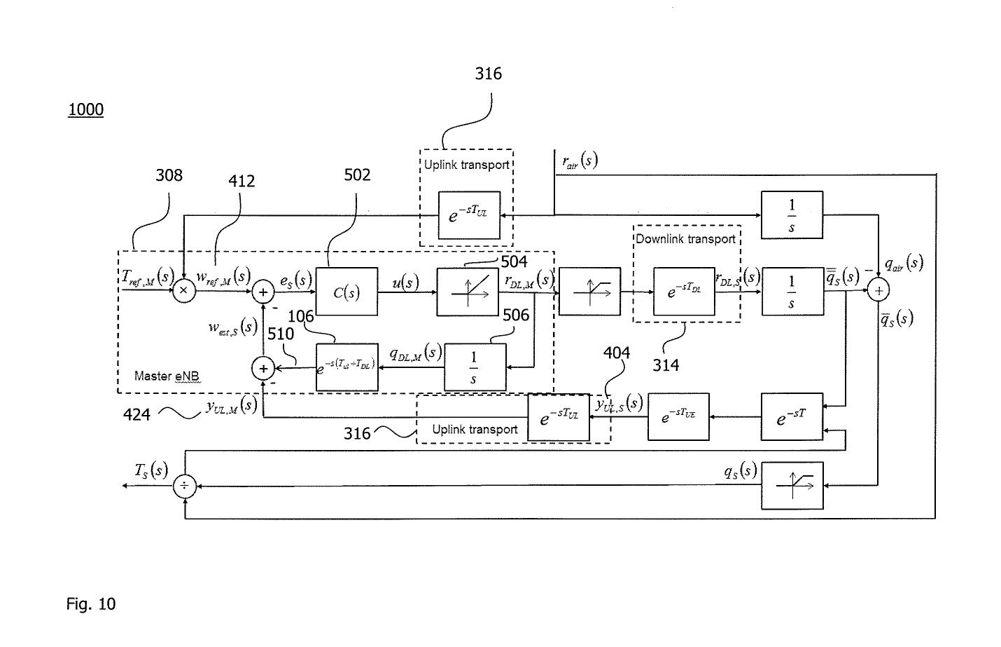

FIG. 10 shows a schematic block diagram for a detailed system implementation of the technique achieving a delay-compensated window-based flow control mechanism. Like reference signs indicate corresponding features. The operators 1/s and s (e.g., in the blocks 506, 600, 700 and 1000) for the MeNB 308 and the downlink transport link 316, respectively, cancel each other. The result is two cascaded saturations with gains varying between 0 and 1. Therefore, they can be treated as one when the loop gain is calculated. The resulting block diagram of a complete control system implementation is depicted in FIG. 10.

For an implementation of the controller filter 502 in a digital computer, the continuous time filter may be transformed to a discrete time filter, e.g., by replacement of the Laplace transform variable s which represents differentiation, to q⁻¹ which represents a shift backward in time as q⁻¹u(t)=u(t−T_{S}), where u(t) represents a signal varying in time and where T_{S} denotes the sampling period. One often used transformation in prior art is the so called Tustin's approximation given by

$$s -> \frac{2}{{T}_{S}} \frac{1 - {q}^{- 1}}{1 + {q}^{- 1}}$$

Tustin's approximation maps a stable continuous time filter onto a stable discrete time filter. Furthermore, its approximation accuracy is of second order which is a further advantage.

To explain the controller development, a continuous time controller filter is first designed using one of many available design methods of the prior art. As an example the result could be a so called lead filter given in its simplest form as

$$C ( s ) = KN \frac{s + b}{s + NB} .$$

Here K, N and b are parameters obtained from the applied controller design method. This determines the exact frequency selective properties of the controller filter.

The transformation to a discrete time filter then consists of insertion of Tustin's approximation in the lead filter. After some simplifications the following discrete time filter is obtained

$$C ( {q}^{- 1} ) = KN \frac{( 2 + {bT}_{S} ) + {q}^{- 1} ( - 2 + {bT}_{S} )}{( 2 + {NbT}_{S} ) + {q}^{- 1} ( - 2 + {NbT}_{S} )} .$$

Next noting that in a feedback situation, the controller filter of FIG. 3 would take the signal before the filter and filter it to obtain the signal after the filter. These signals are denoted e(t) (i.e., the control error) and u(t) (i.e., the control signal), respectively. Hence, it holds that

$$u ( t ) = KN \frac{( 2 + {bT}_{S} ) + {q}^{- 1} ( - 2 + {bT}_{S} )}{( 2 + {NbT}_{S} ) + {q}^{- 1} ( - 2 + {NbT}_{S} )} e ( t ) .$$

By inspection, the above is a discrete time infinite impulse response (IIR) filter. Simple algebraic manipulations and using the definition of the time shift operator q⁻¹ results in the following discrete time difference equation

$$u ( t ) = \frac{2 - {NbT}_{S}}{2 + {NbT}_{S}} u ( t - {T}_{S} ) + KN \frac{2 + {bT}_{S}}{2 + {NbT}_{S}} e ( t ) + KN \frac{- 2 + {bT}_{S}}{2 + {NbT}_{S}} e ( t - {T}_{S} ) = {r}_{1} u ( t - {T}_{S} ) + {s}_{0} e ( t ) + {s}_{1} e ( t - {T}_{S} ) .$$

Here, r₁, s₀ and s₁ are parameters computed form the controller parameters and the sampling period. If the continuous time filter is stable, so is the resulting difference equation.

The same procedure is followed in case higher order filters are transformed to discrete time.

Delays can be transformed with the same technique, using a Taylor series expansion of the Laplace transform of a delay T, given by e^{-sT}. Another alternative that is well known in prior art and more suited for transformation of a delay to discrete time is the so called zero order hold (ZoH) sampling technique that is commonly applied in prior art in the field of control. To summarize this technique, the continuous time filter, possibly with a delay incorporated, is formulated as a differential equation. In case the order is higher than 1 the differential equation will be a vector differential equation. For linear systems like the one of the present application, such solution has a well known and unique general solution that can be written down as an integration formula. The transformation to discrete time then only requires that the integration solution formula is applied from one sampling instance to the next. By solving the resulting integrals, parameters such as r₁, s₀ and s₁ are obtained. The result is a difference equation.

Moreover, the controller design and the above transformation may be performed once for manufacture. The controller filter is configured in terms of the discrete time parameters, here denoted r₁, s₀ and s₁. There is hence no need to re-compute anything but the difference equation above. That requires 1 multiply and two multiply and add operations per sampling period. This is a negligible computational complexity.

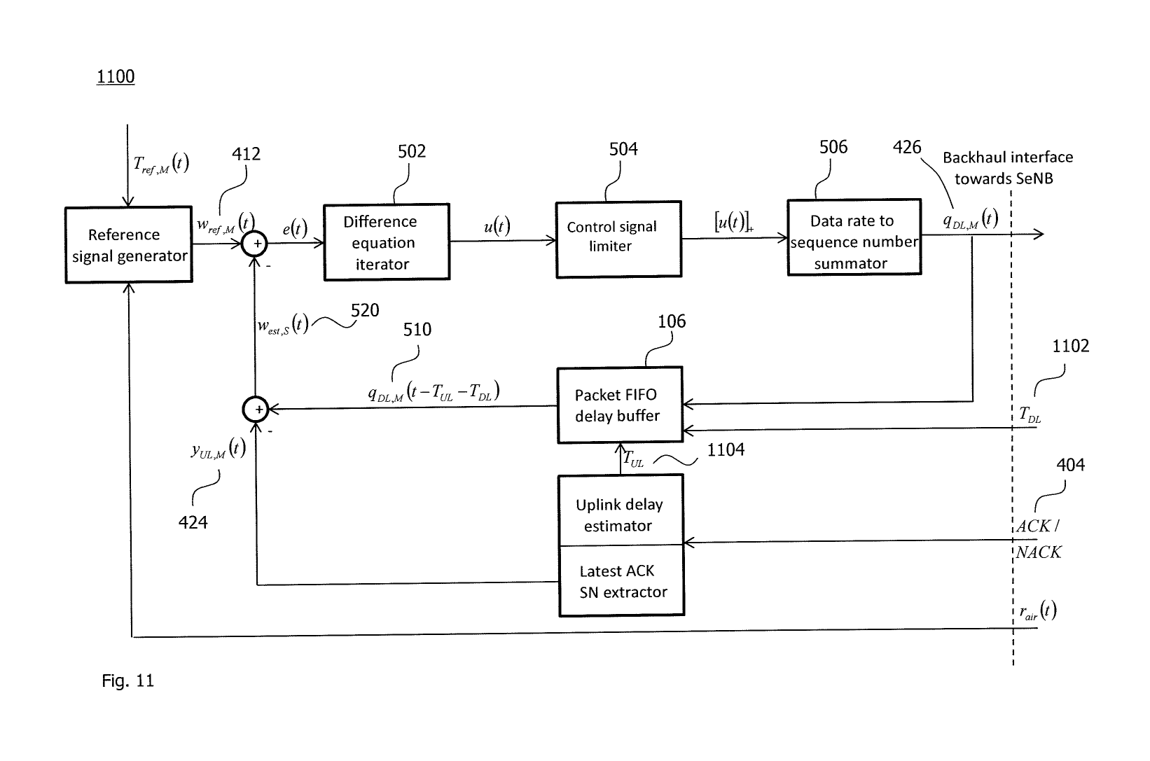

An implementation of the filter 502 is described with reference to FIG. 11 including a schematic block diagram 1100 of the discrete time controller implementation in the MeNB 308. The SeNB 310 functionality for the control loop may be limited to sampling of the needed signals.

FIG. 11 shows a functional block diagram 1100 of the controller mechanism. The circles represent points where the incoming signals are summed. A minus sign indicates a reversal of sign of the incoming signal (before summation), thereby resulting in signal subtraction.

The block diagram 1100 of FIG. 11 corresponds to the block diagram 500 of FIG. 5 with like reference signs indicating corresponding features. The associated processes in the SeNB 3100 may be restricted to at least one of:
measurement, sampling and signaling of the of the air interface rate to the MeNB 308;
measurement, sampling and signaling of the downlink delay to the MeNB 308; and
measurement, sampling and signaling of the latest ACKed SN number to the MeNB 308.

In FIG. 11, another embodiment is shown, in which the latest acknowledged sequence number is derived from the ACK/NACK flow 404 into the MeNB 308. The SeNB functionality does not need to be further detailed.

The discrete time MeNB flow controller includes a reference signal generator. The reference signal generator derives the reference value w_{ref,M}(t) for the desired number of packets (or sequence number difference) in the queue of the SeNB, this is typically done using a configured reference dwell time value T_{ref,M}(t) for the queue of the SeNB, and the reported air interface rate rₐᵢᵣ(t−T_{UL}) from the SeNB. Typically, the two quantities are just multiplied to result in the reference value w_{ref,M}(t).

The controller further includes a difference equation iterator 503. The block 502 iterates the discrete time difference equation that represents the discretized controller filter. A procedure to obtain the coefficients of the linear difference equation is described above. The input signal to the block 502 includes the control error e(t). The block 502 produces a command signal u(t), representing a commanded data rate.

The controller further includes a control signal limiter 504. The data rate can obviously not be negative, since there is no downlink signaling of packets, from the SeNB to the MeNB. The function of the control signal limiter is therefore to modify any negative u(t) to 0. This is denoted by the operator [ ]₊ in FIG. 11.

The controller further includes a data rate to sequence number summator 506. The task of the controller includes computing the number of packets to send in the next sampling period according to the step 208. This is so since the mechanism is based on a window-based controller for the packets in flight. To go from the rate output [u(t)]₊ to the new sequence number, an integration is implemented in the mechanism. In discrete time, the integration is reduced to a summation to get the latest sequence number 426 sent this sampling period.

The controller further includes a packet FIFO delay buffer. The maximum sequence number 426 that was sent towards the SeNB 310 during each sampling period, as well as the absolute time, is entered into this buffer, e.g., for later comparison to the latest acknowledged sequence number 424 from the SeNB 310. The function block may be implemented by a FIFO buffer, e.g., for at least 2 values per sampling period.

The controller further includes an uplink delay estimator. Based on time tagging of ACK/NACKs in the SeNB 310 and an absolute time shared between the MeNB 308 and the SeNB 310, the uplink delay time 1104 of the uplink is estimated in this block. To provide a smooth estimate, filtering may be applied.

The controller further includes a latest ACK SN extractor. This block extracts the sequence number 424 from the signal received from the SeNB 310. The extracted signal becomes y_{UL,M}(t).

For configuring a frequency-shaping feedback filter C(s) shown at reference sign 502, the stability of the feedback loop may be computed. That is done with the use of the Popov criterion which is described, e.g., in C. A. Desoer and M. Vidyasagar, “Feedback Systems, Input-Output Properties”, pp. 186-191, Academic Press, 1975. This criterion is based on the following definitions:

Lₚ denotes a space of functions that fulfill

$${‖ f ( \cdot ) ‖}_{p}^{p} = {\int }_{0}^{∞} {\vert f ( t ) \vert}^{p} dt < ∞ .$$

A mapping A is Lₚ-stable, if there are constants k₁⁰ and k₂ such that

∥Af∥ₚ≤k₁∥f∥ₚ+k₂.

A denotes a set of distributions

$$f ( t ) = {\sum }_{i = 0}^{∞} {f}_{i} δ ( t - {T}_{i} ) + {f}_{A} ( t ) , t \geq 0 , wherein {\sum }_{i = 0}^{∞} \vert {f}_{i} \vert < ∞ and$$

$${\int }_{0}^{∞} \vert {f}_{A} ( t ) \vert dt < ∞ .$$

Â denotes the set of Laplace transforms of distributions in A.

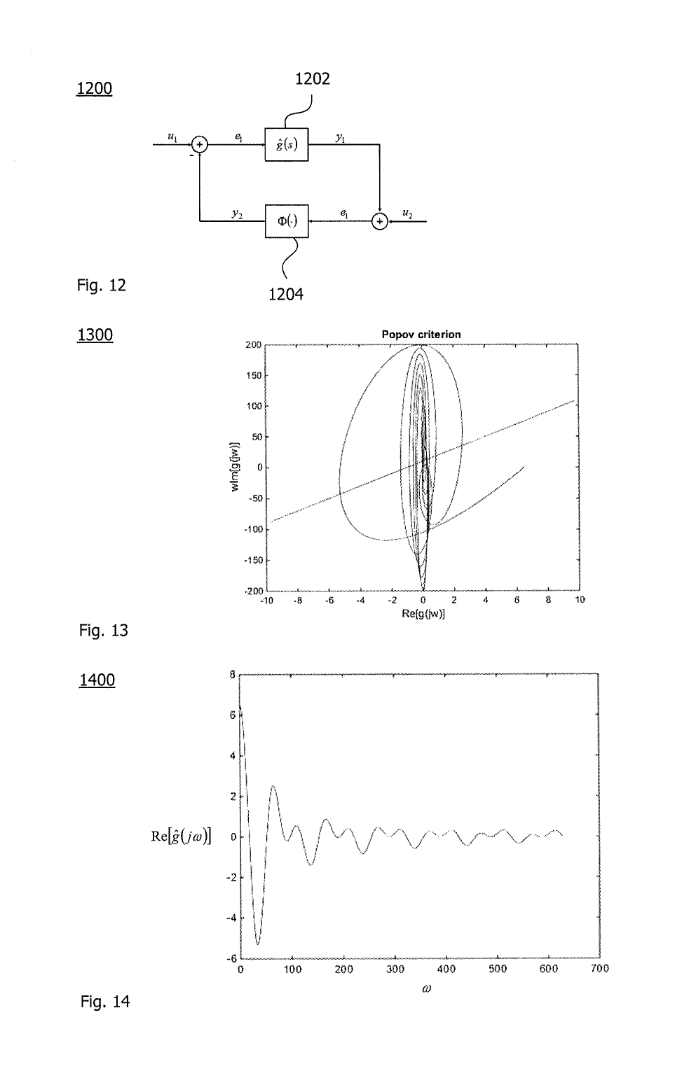

The Popov stability criterion is valid for the block diagram of FIG. 12. The Popov criterion is given by:

Assume that u₁, u₂, \dot{u}₂∈L₂, that ġ(⋅)∈A, and that 0≤σΦ(σ)≤βσ². Then, the closed-loop system is L₂-stable, if there exists a q>0 such that

$${Re [ ( 1 + jq ω ) \hat{g} ( j ω ) ]}^{′} + \frac{1}{β} = δ > 0$$

$$∀ ω \geq 0.$$

The Popov stability criterion may be interpreted graphically. The graphical interpretation of the condition above is that if the Popov plot of the loop gain ω→Re[ĝ(jω)]+jωIm[ĝ(jω)] lies to the right of a line through −1/β+0j with any positive slope q⁻¹, then the closed-loop system is stable. The Popov line is hence allowed to be rotated to the most beneficial slope around −1/β+0j.

By way of illustration, assume that the controller 108, e.g., the filter 502 acts proportionally to the error e(s). Since the control error represents the number of PDCP PDUs to send during the sampling period T, in the step 208, it follows that the commanded rate is c(s)=K/Tₛ, wherein the constant K=1 in one embodiment.

Let T₁=T_{UL}+T_{DL} and T₂=T+T_{UE}. It is easy to see that the loop gain can be computed by multiplication and summation of the Laplace transforms of the blocks in the loops from the signal r_{DL,M} (s) to u(s). The nonlinearity Φ(⋅) has gain 1 and, hence, β==1.

The loop gain becomes

$$\hat{g} ( s ) = \frac{K}{{T}_{s}} \frac{1}{s} {e}^{- s ( {T}_{UL} + {T}_{DL} )} ( 1 - {e}^{- s ( T + {T}_{UE} )} ) .$$

From the loop gain, it immediately follows that the real and imaginary parts of the complex loop gain frequency function become

$$Re [ \hat{g} ( j ω ) ] = \frac{K}{ω {T}_{s}} ( - sin ( ω {T}_{1} ) ( 1 - cos ( ω {T}_{2} ) ) + cos ( ω {T}_{1} ) sin ( ω {T}_{2} ) ) {\to }_{ω -> ∞} 0 , \\ and$$

$$Im [ \hat{g} ( j ω ) ] = \frac{K}{ω {T}_{s}} ( - cos ( ω {T}_{1} ) ( 1 - cos ( ω {T}_{2} ) ) - sin ( ω {T}_{1} ) sin ( ω {T}_{2} ) ) {\to }_{ω -> ∞} 0.$$

Noting that the loop gain is strictly proper, the Popov plot 1300 in FIG. 13 results for the parameters K=1, Tₛ=0.010s, T_{UE}=0.005s, T=0.060s, T_{DL}=0.030s and T_{UL}=0.030s.

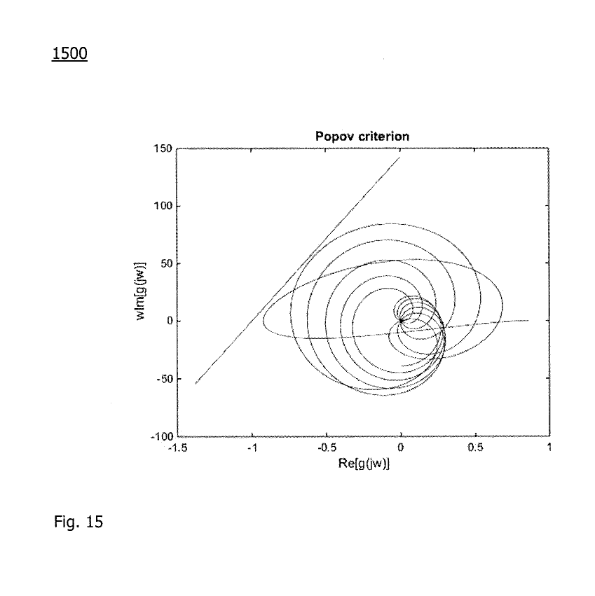

It can immediately be seen from plot 1300 that stability is not implied by the Popov criterion in this case. The reason is that the low-frequency parts of the curve 1300 passes to the left of parts of the Popov line, irrespective how this line is turned around −1. To see that it is the lower frequencies that are the problem, FIG. 14 shows a plot 1400 of the real part of the Popov plot, as a function of the angular frequency ω. Clearly, the amplitude is highest for the lower frequencies.

In an advanced embodiment, the controller filter C(s) shown at reference sign 502 is selected as a frequency-selective filter, e.g., based on a frequency-selective Laplace transform, with a low gain for lower frequencies.

For low-frequency attenuating, a frequency-shaping controller filter 502 is described. In one embodiment, the frequency-shaping filter 502 is selected as

$$C ( s ) = K \frac{s + b}{s + Nb}$$

wherein the parameters include:
K=1 which sets the high-frequency gain to 1, since

$$C ( j ω ) = K \frac{j ω + b}{j ω + Nb} {\to }_{ω -> ∞} 1.$$

b determines the angular frequency where the gain starts to rise significantly.
N is the low-frequency gain attenuation factor since

$$C ( j ω ) = K \frac{j ω + b}{j ω + Nb} {\to }_{ω -> ∞} \frac{1}{N} .$$

A study of FIG. 13 reveals that the low-frequency gain can be reduced by a factor of 7.5 to make the size of the real part less than one. This low-frequency gain is needed in regions for which the plot 1300 shows the real part to be greater than 1, i.e. below 150 rad/s.

Hence, N=7.5 and b=150/N are suitable parameters. This choice of C(s) results in the Popov plot 1500 in FIG. 15 which establishes that the closed loop system is globally stable.

Any of above embodiments and implementations may include measurements of the downlink transport delay 1102 and the uplink transport delay 1104, e.g., together with signaling means for signaling of the downlink transport delay 1102 to the flow control mechanism, i.e., the module 106, of the MeNB 308.

A sequence number 426 of the last sent packet may be delayed, e.g., by using a delay buffer 106 in the MeNB 308. The delayed sequence number 510 may be used to represent an estimate of the top 406 of the window 402 in the SeNB 310. This top 406 of the window 402 may be used within the flow control according to the step 208 performed by the MeNB 308.

Frequency-shaping control filtering may be performed when computing the control signal that generates the control command on the number of further data packets 430 to be send to the SeNB 310, in the present sampling time instance. The result of this is an embodiment of the device 100 that is guaranteed to be stable, i.e. that give consistent control of the SeNB window 402, thereby providing improved performance and a better user experience.

As has become apparent from above description of exemplary embodiments, end user experience may be improved by lower download times due to a more accurate and more efficient feedback control of a buffer in the SeNB. A globally stable control algorithm, which is guaranteed to perform consistently at all times, may be realized.

At least some embodiments account for delays and consistently user delayed information available to a control mechanism in the MeNB. The overall quantity that can be accurately controlled by the mechanism includes the dwell time and/or a data volume in the buffer window of the SeNB. Thus, control accuracy become significantly improved and/or situations of rapid changes in the delays can be handled. The feedback control objective can be based on measurements.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1-31. (canceled)

32. A method of sending data packets in a radio access network, the radio access network including a master base station and a secondary base station for providing multi-connectivity to a user equipment, the method comprising:
sending or controlling sending, via a first link, at least one first data packet to be transmitted through the secondary base station to the user equipment;
receiving, via a second link, a feedback including an acknowledgment for at least one second data packet transmitted through the secondary base station to the user equipment; and
sending or controlling sending, via the first link, at least one further data packet to be transmitted through the secondary base station to the user equipment, wherein the sending or controlling sending of the at least one further data packet depends on the at least one first data packet, a delay associated with the first link and the second link, and the feedback for the at least one second data packet.

33. The method of claim 32, further comprising:
delaying an indicator for the at least one first data packet by a delay time depending on the first link and the second link,
wherein the sending or controlling sending of the at least one further data packet depends on the delayed indicator for the at least one first data packet and the feedback for the at least one second data packet.

34. The method of claim 32, wherein the first link is a backhaul link from the master base station to the secondary base station, and/or the second link is a backhaul link from the secondary base station to the master base station.

35. The method of claim 33, wherein the delay time corresponds to a packet round trip from the master base station to the secondary base station and from the secondary base station to the master base station.

36. The method of claim 33, further comprising measuring the delay time or receiving a measurement for determining the delay time.

37. The method of claim 33, wherein the delay time is estimated based on a time measured for a one-way packet trip from the master base station to the secondary base station and/or from the secondary base station to the master base station.

38. The method of claim 32, further comprising:
storing, in a master buffer at the master base station, data packets received from a core network for transmission to the user equipment using the multi-connectivity;
wherein the at least one first data packet and/or the at least one further data packet sent to the secondary base station is retrieved from the master buffer and sent from the master base station.

39. The method of claim 32, wherein each of the data packets includes a sequence number.

40. The method of claim 33:
wherein each of the data packets includes a sequence number;
wherein the indicator includes the sequence number of the at least one first data packet; and
wherein the acknowledgement includes the sequence number of the at least one second data packet.

41. The method of claim 40, wherein the sending or controlling sending of the at least one further data packet depends on the difference between the sequence number of the delayed indicator and the sequence number of the acknowledgment.

42. The method of claim 41:
wherein the feedback further includes a requested window size; and
wherein a number of the at least one further data packet depends on the difference and the requested window size.

43. The method of claim 33, wherein the indicator of the at least one first data packet results from and/or is subjected to an infinite impulse response filter that depends on the delay time.

44. The method of claim 43, wherein the filter is frequency-selective.

45. The method of claim 43, wherein the filter is adapted to the delay time for achieving stability.

46. A non-transitory computer readable recording medium storing a computer program product for controlling the sending data packets in a radio access network, the radio access network including a master base station and a secondary base station for providing multi-connectivity to a user equipment, the computer program product comprising software instructions which, when run on processing circuitry of one or more computing devices, causes the one or more computing devices to:
send or control sending, via a first link, at least one first data packet to be transmitted through the secondary base station to the user equipment;
receive, via a second link, a feedback including an acknowledgment for at least one second data packet transmitted through the secondary base station to the user equipment; and
send or control sending, via the first link, at least one further data packet to be transmitted through the secondary base station to the user equipment, wherein the sending or controlling sending of the at least one further data packet depends on the at least one first data packet, a delay associated with the first link and the second link, and the feedback for the at least one second data packet.

47. A device for sending data packets in a radio access network, the radio access network including a master base station and a secondary base station for providing multi-connectivity to a user equipment, the device comprising:
processing circuitry;
memory containing instructions executable by the processing circuitry whereby the device is operative to:
send or control sending, via a first link, at least one first data packet to be transmitted through the secondary base station to the user equipment;
receive, via a second link, a feedback including an acknowledgment for at least one second data packet transmitted through the secondary base station to the user equipment; and
send or control sending, via the first link, at least one further data packet to be transmitted through the secondary base station to the user equipment, wherein the sending or controlling sending of the at least one further data packet depends on the at least one first data packet, a delay associated with the first link and the second link, and the feedback for the at least one second data packet.

18. A master base station for sending data packets in a radio access network, the radio access network including the master base station and a secondary base station for providing multi-connectivity to a user equipment, the master base station comprising:
processing circuitry;
memory containing instructions executable by the processing circuitry whereby the master base station is operative to:
send or control sending, via a first link, at least one first data packet to be transmitted through the secondary base station to the user equipment;
receive, via a second link, a feedback including an acknowledgment for at least one second data packet transmitted through the secondary base station to the user equipment;
send or control sending, via the first link, at least one further data packet to be transmitted through the secondary base station to the user equipment, wherein the sending or controlling sending of the at least one further data packet depends on the at least one first data packet, a delay associated with the first link and the second link, and the feedback for the at least one second data packet.

49. The master base station of claim 48:
wherein the instructions are such that the master base station is operative to delay an indicator for the at least one first data packet by a delay time depending on the first link and the second link;
wherein the sending or controlling sending of the at least one further data packet depends on the delayed indicator for the at least one first data packet and the feedback for the at least one second data packet.

50. The master base station of claim 48, wherein the first link is a backhaul link from the master base station to the secondary base station, and/or the second link is a backhaul link from the secondary base station to the master base station.

51. The master base station of claim 49, wherein the delay time corresponds to a packet round trip from the master base station to the secondary base station and from the secondary base station to the master base station.

42. The master base station of claim 49, wherein the instructions are such that the master base station is operative to measure the delay time or receive a measurement for determining the delay time.

53. The master base station of claim 49, wherein the delay time is estimated based on a time measured for a one-way packet trip from the master base station to the secondary base station and/or from the secondary base station to the master base station.

54. The master base station of claim 48:
wherein the instructions are such that the master base station is operative to store, in a master buffer at the master base station, data packets received from a core network for transmission to the user equipment using the multi-connectivity;
wherein the at least one first data packet and/or the at least one further data packet sent to the secondary base station is retrieved from the master buffer and sent from the master base station.

55. The master base station of claim 48, wherein each of the data packets includes a sequence number.

56. The master base station of claim 49:
wherein each of the data packets includes a sequence number;
wherein the indicator includes the sequence number of the at least one first data packet; and
wherein the acknowledgement includes the sequence number of the at least one second data packet.

57. The master base station of claim 56, wherein the instructions are such that the master base station is operative to send or control sending the at least one further data packet based on the difference between the sequence number of the delayed indicator and the sequence number of the acknowledgment.

58. The master base station of claim 57:
wherein the feedback further includes a requested window size; and
wherein a number of the at least one further data packet depends on the difference and the requested window size.

59. The master base station claim 49, wherein the indicator of the at least one first data packet results from and/or is subjected to an infinite impulse response filter that depends on the delay time.

60. The master base station of claim 59, wherein the filter is frequency-selective.

61. The master base station of claim 59, wherein the filter is adapted to the delay time for achieving stability.
